(19) United States
(12) Patent Application Publication
(10) Pub. No.: US 2001/0026390 A1
(43) Pub. Date: Oct. 4, 2001

(54) Optical receiver

(76) Inventor: Klaus Braun, Stuttgart (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/799,574

(22) Filed: Mar. 7, 2001

(30) Foreign Application Priority Data
Mar. 8, 2000 (DE) 100 11 287.0

(51) Int. Cl. H04B 10/06; H04B 10/12

(52) U.S. Cl. 359/189; 359/195

(57) ABSTRACT

The object of the invention is to make available an optical receiver which can receive optical signals in optimized fashion. This object is achieved by an optical receiver (5) which in particular is characterized in that the two ends of two optical fibers (8, 9; 12, 13; 16, 17), which serve to transmit optical signals, are arranged directly in front of the active surface (7; 11; 15) of the photo-diode (6; 10; 14) of the optical receiver (5) such that the photo-diode (6; 10; 14) can directly receive optical signals from the two optical fibers (8, 9; 12, 13;, 16, 17). This has the advantage that no additional losses occur and neither are additional components required. Furthermore the production costs are minimized and the reception quality is optimized. In the first exemplary embodiment the two optical fibers (8, 9) are arranged at an angle of 10 to 90° relative to one another, in the second exemplary embodiment the two optical fibers (12, 13) are arranged in parallel with one another and the end faces of the fiber ends are bevelled and form an angle of 90 to 180° with one another, and in the third exemplary embodiment the two optical fibers (16, 17) are arranged in parallel to one another and the active surface (15) of the photo-diode (14) has the form of an oval surface.

The invention relates to an optical receiver.

In optical systems, optical transmitters frequently contain laser diodes for the generation of optical signals which are transmitted via optical fibres, for example glass fibre cables, to optical receivers which frequently use photo-diodes for the electro-optical conversion.

Optical systems are often designed as point-to-multipoint distribution networks. Via a passive optical distribution network comprising optical lines and optical splitters, optical signals are transmitted from an optical transmitter to a plurality of optical receivers. Such an optical system is used for example for the distribution of cable television signals.

If a disturbance occurs on an optical sub-section, for example due to a fibre breakage caused for example by excavation work, at least one optical receiver, but generally a plurality of optical receivers, no longer receive(s) any optical signals from the optical transmitter. To prevent this, many optical systems are already equipped with so-called path-link-protection. Path-link-protection makes an alternative path available in the event that a main path is affected by a disturbance. The optical transmitter must be designed such that in the absence of a fault it transmits optical signals at least via the optical main lines and in the case of a fault it transmits optical signals additionally or exclusively via the alternative lines. The optical receivers must be designed such that in the absence of a fault they can receive optical signals via the main lines and in the case of a fault they can receive optical signals via the alternative lines.

Three methods of implementing optical receivers for optical path-link-protection systems are currently known and these will be briefly described in the following:

1. A standard optical receiver with one input and one photo-diode is used. An optical switch is positioned in front of the optical receiver, which switch forwards the optical signals of the main line in the absence of a fault and the optical signals of the alternative line in the case of a fault. One switch is required for each optical receiver. The switch and the means for the control thereof are relatively costly. Additionally the switch is relatively prone to faults.

2. Two standard optical receivers, each with one input and one-photo-diode, are used. One optical receiver serves to receive the optical signals via the main line and the other to receive optical signals via the alternative line. The outputs of both receivers lead to an electric switch or a combiner. This variant is very costly.

3. A standard optical receiver with one input and one photo-diode is used. An optical combiner is positioned in front of the optical receiver. The optical combiner superimposes the optical signals received via the main line upon the optical signals received via the alternative line. Monomode fibres are used in the optical combiner. The optical combiner generates a power loss of 3 dB. This reduces the signal-to-noise ratio, which diminishes the reception quality.

The object of the invention is to make available an optical receiver which can receive optical signals in optimised fashion.

This object is achieved by an optical receiver according to claim 1. The optical receiver is characterised in particular in that the two ends of two optical fibres, which serve to transmit optical signals, are arranged directly in front of the active surface of the photo-diode of the optical receiver such that the photo-diode can directly receive optical signals from both optical fibres.

This has the advantage that no additional losses occur and neither are any additional components required. Furthermore, the production costs are minimised and the reception quality is optimised.

Advantageous developments of the invention are described in the dependent claims.

In the following the invention will be explained in the form of four exemplary embodiments making reference to four Figures wherein:

FIG. 1 illustrates a portion of a path-link-protection system;

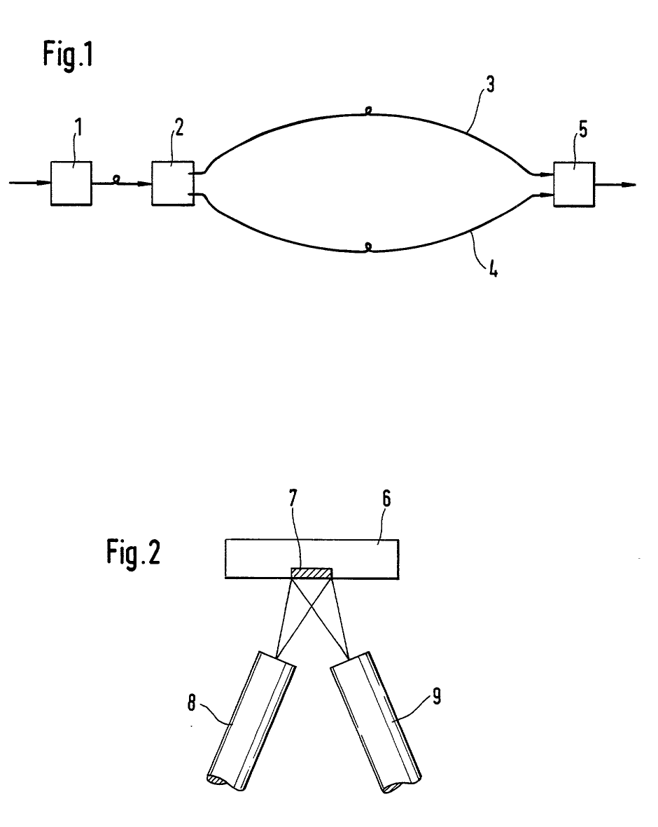

FIG. 2 is a schematic illustration of a portion of a first variant of an optical receiver according to the invention;

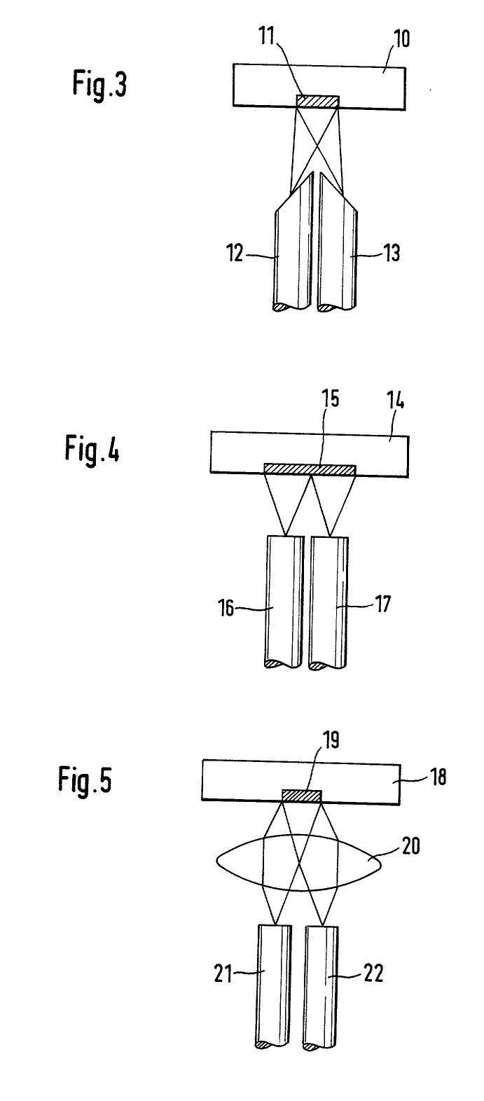

FIG. 3 is a schematic illustration of a portion of a second variant of an optical receiver according to the invention;

FIG. 4 is a schematic illustration of a portion of a third variant of an optical receiver according to the invention and

FIG. 5 is a schematic illustration of a portion of a fourth variant of an optical receiver according to the invention.

The first exemplary embodiment will now be explained with reference to FIGS. 1 and 2. FIG. 1 illustrates a portion of a path-link-protection system. The illustrated portion comprises an optical transmitter 1, an optical switch 2, a main line 3, an alternative line 4 and an optical receiver 5.

The optical transmitter contains a laser diode by means of which electrical signals to be transmitted, which have already been modulated and optionally compressed, are directly converted into optical signals. The optical signals are transmitted to the optical switch 2. Normally, i.e. in the absence of a fault, the optical switch 2 forwards the received optical signals to the optical receiver 5 via the optical main line 3, which for example has the form of an optical glass fibre line. In the case of a fault, i.e. when a disturbance occurs on the main line 3, for example due to excavation work, the optical receiver 5 can no longer detect the optical signals transmitted via the main line 3. In this case the optical switch 2 forwards the optical signals not via the main line 3 but via the alternative line 4, which for example has the form of an optical glass fibre line. The optical signals now reach the optical receiver 5 via the alternative line 4. In both cases, i.e. when the optical signals are transmitted via the main line 3 and when they are transmitted via the alternative line 4, the optical receiver 5 must be capable of detecting the optical signals. It is specially designed for this purpose, as will be further explained in the following with reference to FIG. 2.

FIG. 2 illustrates a portion of a first variant of an optical receiver according to the invention. The illustrated portion comprises a photo-diode 6 and two optical fibres 8 and 9.

The photo-diode 6 has an active surface 7 which is impinged upon by the optical signals exiting from the optical fibres 8 and 9 and with the aid of which the optical-electrical conversion of the optical signals is performed. The generated electrical signals are further processed via standard processing devices containing for example a processor, a memory, a decoder, a decompresser etc. In the case of cable television distribution systems, the processing devices can also simply have the form of amplifiers.

The two ends of the two optical fibres 8 and 9, which serve to transmit the optical signals, are arranged directly in front of the active surface 7 of the photo-diode 6 such that the photo-diode 6 can directly receive optical signals from both optical fibres 8 and 9. The two optical fibres 8 and 9 are arranged at an angle of 10 to 90° relative to one another. In a preferred embodiment the two optical fibres 8 and 9 are arranged at an angle of 10 to 20° relative to one another. The axis of the optical fibre 8 can for example be aligned at right angles to the active surface 7 while the axis of the optical fibre 9 is aligned at an angle of 10° to the axis of the optical fibre 8 on the right or left beside the optical fibre 8.

The optical signals exiting from the optical fibres 8 and 9 each generate a light cone which impinges on the photo-diode 6. Ideally the surface of each light cone corresponds to the surface of the active surface 7 of the photo-diode 6. Due to a defined distance between fibre end and active surface 7, the congruence of light cone surface and active surface 7 can be adjusted. Advantageously, mechanical aligning devices in which the fibre ends are fixed in position are provided in the optical receiver. The aligning devices contain for example grooves in which the fibre ends are clamped. The aligning devices are designed such that upon the insertion of the two optical fibres 8 and 9, a defined angle between the fibre ends and a defined distance from the active surface 7 are automatically set.

The size of the active surface 7 is optimised for the reception of optical signals from an optical fibre and thus corresponds to an active surface of a standard photo-diode 6. The positioning of the two optical fibres 8 and 9 at a defined angle relative to one another provides that optical signals from two optical fibres can also be received by means of one commercially available photo-diode 6. Air is present between the photo-diode 6 and the optical fibres 8 and 9. The optical signals exiting from the optical fibres 8 and 9, which correspond respectively to the main line 3 and the alternative line 4 in FIG. 1, directly impinge on the active surface 7, thereby contributing to an optimised reception. In the absence of a fault, optical signals are transmitted via the main line 3 and impinge on the photo-diode 6 via the optical fibre 8. In the case of a fault, the optical signals are transmitted via the alternative line 4 and impinge upon the photo-diode 6 via the optical fibre 9.

To reduce optical reflections, for example optical signals exiting from the optical fibre 8 which are reflected on the active surface 7 such that they enter the optical fibre 9, the photo-diode 6 can be arranged obliquely with an axis of rotation falling in the drawing plane and extending parallel to the active surface 7.

The second exemplary embodiment will now be explained with reference to FIG. 3. FIG. 3 illustrates a portion of a second variant of an optical receiver according to the invention. The illustrated portion comprises one photo-diode 10 and two optical fibres 12 and 13.

The photo-diode 10 has an active surface 11 which is impinged upon by the optical signals exiting from the optical fibres 12 and 13 and with the aid of which the optical-electrical conversion of the optical signals is performed. The generated electrical signals are further processed by means of standard processing devices, containing for example a processor, a memory, a decoder, a decompresser etc. In the case of cable television distribution systems, the processing devices can also simply have the form of amplifiers.

The two ends of the two optical fibres 12 and 13, which serve to transmit the optical signals, are arranged directly in front of the active surface 11 of the photo-diode 10 such that the photo-diode 10 can directly receive optical signals from the two optical fibres 12 and 13. The two optical fibres 12 and 13 are arranged in parallel to one another. The end faces of the fibre ends are bevelled and form an angle of 90 to 180° with one another. Due to the bevelled termination of the fibres 12 and 13, the exiting optical signals are deflected from the vertical plane at the glass-air junction and impinge upon the active surface 11.

The optical signals exiting from the optical fibres 12 and 13 each generate a light cone which impinges on the photo-diode 10. Ideally the surface of each light cone corresponds to the surface of the active surface 11 of the photo-diode 10. Due to a defined distance between fibre end and active surface 11, the congruence of light cone surface and active surface 11 can be adjusted.

Advantageously, mechanical aligning devices in which the fibre ends are fixed in position are provided in the optical receiver. The aligning devices contain grooves for example, in which the fibre ends are clamped. The aligning devices are designed such that upon the insertion of the two optical fibres 12 and 13, these automatically extend in parallel and at a defined distance from the active surface 11.

The size of the active surface 11 is optimised for the reception of optical signals from an optical fibre and thus corresponds to an active surface of a standard photo-diode 11. The positioning of the two optical fibres 12 and 13, comprising fibre ends with bevelled end faces, provided that optical signals from two optical fibres can also be received by means of one standard photo-diode 10. Air is present between the photo-diode 10 and the optical fibres 12 and 13. The optical signals exiting from the optical fibres 12 and 13, which correspond respectively to the main line 3 and the alternative line 4 according to FIG. 1, directly impinge on the active surface 11, thereby contributing to an optimised reception. In the absence of a fault, optical signals are transmitted via the main line 3 and impinge on the photo-diode 10 via the optical fibre 12. In the case of a fault, the optical signals are transmitted via the alternative line 4 and impinge on the photo-diode 10 via the optical fibre 13.

To reduce optical reflections, for example optical signals exiting from the optical fibre 12 which are reflected on the active surface 11 such that they enter the optical fibre 13, the photo-diode 10 can be arranged obliquely with an axis of rotation falling in the drawing plane and extending in parallel to the active surface 11.

The parallel arrangement of the optical fibres 12 and 13 is a particularly space-saving variant. This has advantages in the case of so-called packaging, i.e. when a plurality of photo-diodes, for example a plurality of optical receivers, are positioned next to one another. Packaging is also understood as the installation in a housing of a diode chip with fibre coupling. Very often a cylindrical housing is used, a chip being arranged on the base of said housing and the fibre leading out laterally therefrom. In the second exemplary embodiment both fibres can lead out in parallel in a fibre holder (fixing).

The third exemplary embodiment will now be explained with reference to FIG. 4. FIG. 4 illustrates a portion of a third variant of an optical receiver according to the invention. The illustrated portion comprises a photo-diode 14 and two optical fibres 16 and 17.

The photo-diode 14 has an active surface 15 which is impinged upon by the optical signals exiting from the optical fibres 16 and 17 and with the aid of which the optical/electrical conversion of the optical signals is performed. The generated electrical signals are further processed by means of standard processing devices containing for example a processor, a memory, a decoder, a decompresser etc. In the case of cable television distribution systems, the processing devices can also simply have the form of amplifiers.

The two ends of the two optical fibres 16 and 17, which serve to transmit the optical signals, are arranged directly in front of the active surface 15 of the photo-diode 14 such that the photo-diode 14 can directly receive optical signals from both optical fibres 16 and 17. The two optical fibres 16 and 17 are arranged in parallel to one another. The active surface 15 of the photo-diode 14 has the form of an oval. It is larger than the standard size of an active surface. A standard active surface of a photo-diode is circular and thus optimised to receive a light cone. The oval active surface 15 according to the invention is optimised to receive two light cones. The two light cones can overlap or impinge on the active surface 15 one beside another with no overlap. To reduce the capacity, the shape of the active surface 15 is not circular but such as to encompass both light cones with only a minimal excess and ideally corresponds exactly to the surface of the two light cones. An optimal shape of the active surface 15 is therefore that which corresponds to the maximum extent to the light cones impinging upon it, for example an oval, oblong, figure of eight, two juxtaposed circular surfaces, two partially overlapping circular surfaces or the like.

Due to a defined distance between fibre end and active surface 15, the congruence of light cone surface and active surface 15 can be adjusted. Advantageously, mechanical aligning devices in which the fibre ends are fixed in position are provided in the optical receiver. The aligning devices contain grooves, for example, in which the fibre ends are clamped. The aligning devices are designed such that upon the insertion of the two optical fibres 16 and 17, these automatically extend in parallel and at a defined distance from the active surface 15.

Air is present between the photo-diode 14 and the optical fibres 16 and 17. The optical signals exiting from the optical fibres 16 and 17, which correspond respectively to the main line 3 and the alternative line 4 in FIG. 1, directly impinge on the active surface 15, thereby contributing to an optimised reception. In the absence of a fault, optical signals are transmitted via the main line 3 and impinge on the photo-diode 14 via the optical fibre 16. In the case of a fault, the optical signals are transmitted via the alternative line 4 and impinge on the photo-diode 14 via the optical fibre 17.

To reduce optical reflections, for example optical signals exiting from the optical fibre 16 which are reflected on the active surface 15 such that they enter the optical fibre 17, the photo-diode 14 can be arranged obliquely with an axis of rotation falling in the drawing plane and extending in parallel to the active surface 15.

The parallel arrangement of the optical fibres 16 and 17 is a particularly space-saving variant. This has advantages in the case of so-called packaging, i.e. when a plurality of photo-diodes, for example a plurality of optical receivers, are positioned next to one another. Packaging is also understood as the installation in a housing of a diode chip with fibre coupling. Very often a cylindrical housing is used with the chip arranged on the base of said housing and the fibre leading out laterally therefrom. In the third exemplary embodiment the two fibres can lead out in parallel in a fibre holder (fixing).

In the third exemplary embodiment, a new type of photo-diode with an oval (or the like) active surface is used. This new photo-diode can also be used in the case of the first two exemplary embodiments. Due to the use of the new photo-diode, optionally with an oval active surface smaller in size than the oval active surface 15, in the first exemplary embodiment it is possible to provide a smaller angle between the two optical fibres; in the second exemplary embodiment it is possible to provide a larger angle between the bevelled end faces of the fibre ends. In the first exemplary embodiment this is advantageous for the packaging and in the second exemplary embodiment it simplifies the production of the fibre ends.

The fourth exemplary embodiment will now be explained with reference to FIG. 5. FIG. 5 illustrates a portion of a fourth variant of an optical receiver according to the invention. The illustrated portion comprises a photo-diode 18, a refractive medium 20 and two optical fibres 21 and 22.

The photo-diode 18 has an active surface 19 which is impinged upon by the optical signals exiting from the optical fibres 21 and 22 when they have passed through the refractive medium 20 and with the aid of which the optical/electrical conversion of the optical signals is performed. The generated electrical signals are further processed by means of standard processing devices containing for example a processor, a memory, a decoder, a decompresser etc. In the case of cable television distribution systems, the processing devices can also simply have the form of amplifiers.

The two ends of the two optical fibres 21 and 22, which serve to transmit the optical signals, are arranged together with the optical medium 20 directly in front of the active surface 19 of the photo-diode 18, such that the photo-diode 10 can receive optical signals from both optical fibres 12 and 13. The two optical fibres 21 and 22 are arranged in parallel to one another. Optionally the end faces of the fibre ends can be bevelled and form an angle of 90 to 180° with one another. Due to the bevelled termination of the fibres 21 and 22, the exiting optical signals are deflected from the vertical plane at the glass-air junction and impinge on the refractive medium 20.

The optical signals exiting from the optical fibres 12 and 13 each generate a light cone which is refracted in the refractive medium and then impinges on the photo-diode 18. Ideally the surface of each refracted light cone corresponds to the surface of the active surface 19 of the photo-diode 18. Due to a defined distance between fibre end and active surface 19, the congruence of light cone surface and active surface 19 can be adjusted. Advantageously, mechanical aligning devices in which the fibre ends are fixed in position are provided in the optical receiver. The aligning devices contain grooves, for example, in which the fibre ends are clamped. The aligning devices are designed such that upon the insertion of the two optical fibres 21 and 22, these automatically extend in parallel and at a defined distance from the active surface 19. Furthermore, a mechanical aligning device is provided for the refractive medium 20. The refractive medium 20 is formed for example by a lens. The lens can have the form of a concave lens. The lens can also have the form of a spherical lens. The concave lens is fixed in position such that its longitudinal axis extends in parallel to the active surface 19 and its transverse axis extends (ideally centrally) through the active surface 19. The two fibre ends 21 and 22 are arranged in parallel on the left and right beside the transverse axis of the lens. The outer light rays of the light cones exiting from the two fibre ends are refracted on passage through the lens, such that they impinge on the outer edges of the active surface 19. The distances between the fibre ends 21, 22, the lens, and the active surface 19, as well as the refractive index governed by the shape of the lens, are selected and mutually adapted such that the impingement surface of the light cones corresponds as far as possible to the size of the active surface 19.

The size of the active surface 19 is optimised to receive optical signals from an optical fibre and thus corresponds to an active surface of a standard photo-diode 18. The positioning of the two optical fibres 21, 22, optionally comprising fibre ends with bevelled end faces to increase the refraction of the light rays, ensures that optical signals from two optical fibres can also be received by means of one standard photo-diode 18. Air is present between the photo-diode 18 and the lens, and between the lens and the optical fibres 21 and 22. The optical signals exiting from the optical fires 21 and 22, which correspond respectively to the main line 3 and the alternative line 4 in FIG. 1, directly impinge on the active surface 19 having passed through the lens, thereby contributing to an optimised reception. In the absence of a fault, optical signals are transmitted via the main line 3 and impinge on the photo-diode 18 via the optical fibre 21. In the case of a fault, the optical signals are transmitted via the alternative line 4 and impinge on the photo-diode 18 via the optical fibre 22.

To reduce optical reflections, for example optical signals exiting from the optical fibre 21 which are reflected on the active surface 19 such that they enter the optical fibre 22, the photo-diode 18 can be arranged obliquely with an axis of rotation falling in the drawing plane and extending in parallel to the active surface 19.

The parallel arrangement of the optical fibres 21 and 22 is a particularly space-saving variant. This has advantages in the case of so-called packaging, i.e. when a plurality of photo-diodes, for example a plurality of optical receivers, are positioned next to one another. Packaging is also understood as the installation in a housing of a diode chip with fibre coupling. Very often a cylindrical housing is used, the chip being arranged on the base thereof and the fibre leading out laterally therefrom. In the second exemplary embodiment the two fibres can lead out in parallel in a fibre holder (fixing).

All four exemplary embodiments are based on the path-link protection system shown in FIG. 1. In the illustrated portion this has the form of a point-to-point system. The invention can also be used in a point-to-multipoint and multipoint-to-multipoint system. A plurality of optical transmitters transmit optical signals to a plurality of optical receivers via a passive optical distribution network comprising optical splitters or an active optical network containing for example optical amplifiers, add-drop multiplexers and/or cross-connectors. The optical receivers can also have the form of optical transceivers.

If, in all four exemplary embodiments, the photo-diode and the aligning devices are integrated, i.e. constructed on one chip, an increase in packing density is achieved. Each optical fibre can be inserted in a groove on the chip. In this way the coupling accuracy can be increased. Additionally this leads to a reduction in production costs. Integrated circuits which perform not only optical but also electrical functions, for example the electrical analysis of the received optical signals by means of an integrated processing device, are normally known as hybrid or opto-electronic circuits. In this way the entire optical receiver, including aligning device, photo-diode and processing device, could be integrated on one chip.

In all four exemplary embodiments the photo-diode receives optical signals from two optical fibres. The invention can also be used in the case of three or more optical fibres, all of which are directed towards one and the same photo-diode. In the first exemplary embodiment, for example one optical fibre is arranged at right angles to the active surface. Two further optical fibres are arranged for example at an angle of 10° on the right and left beside the first optical fibre. In the second exemplary embodiment for example one optical fibre is arranged at right angles to the active surface. The end face of this fibre is not bevelled. Two further optical fibres are arranged for example in parallel on the right and left beside the first optical fibre. The end faces of the second and third optical fibres are bevelled. In the third exemplary embodiment for example one optical fibre is arranged at right angles to the active surface. Two further optical fibres are arranged for example in parallel on the right and left beside the first optical fibre. The active surface of the photo-diode is designed such that it encompasses all three light cones of all three fibres. The active surface has the form for example of an oval, an oblong or the like. The optical fibres could also be arranged in a stacked formation so that the light cones form a type of triangle. Then the active surface likewise has the form for example of a triangle or the like, for example a form comparable with three overlapping circles. In the case of four stacked optical fibres, the active surface can also be of circular or square formation, or can have the form of a four-leaf clover or four superimposed circles.

The fourth exemplary embodiment can also be combined with 15 the third and/or first exemplary embodiment, for example by the use of a non-circular, for example oval, active surface as active surface 19 in FIG. 5 and/or optical fibre ends forming an angle of 10 to 90° with one another as fibre ends 21, 22 in FIG. 5.

1. An optical receiver (5) containing a photo-diode (6; 10; 14),
characterised in that the two ends of two optical fibres (8,9; 12,13; 16,17), which serve to transmit optical signals, are arranged directly in front of the active surface (7; 11; 15) of the photo-diode (6; 10; 14), such that the photo-diode (6; 10; 14) can directly receive optical signals from both optical fibres (8,9; 12,13; 16,17).

2. An optical receiver (5) according to claim 1,
characterised in that a mechanical aligning device is provided for fixing the optical fibres in position.

3. An optical receiver (5) according to claim 1,
characterised in that the two optical fibres (8, 9) are arranged at an angle of 10 to 90° relative to one another.

4. An optical receiver (5) according to claim 1,
characterised in that the two optical fibres (12, 13) are arranged in parallel to one another and that the end faces of the fibre ends are bevelled and form an angle of 90 to 180° relative to one another.

5. An optical receiver (5) according to claim 1,
characterised in that the two optical fibres (16, 17) are arranged in parallel to one another and that the active surface (15) of the photo-diode (14) has the form of an oval surface.

6. A photo-diode (6; 10; 14) according to claim 6,
characterised in that the active surface (7; 11; 15) of the photo-diode (6; 10; 14) has the form of a non-circular surface.

7. A photo-diode (6; 10; 14) according to claim 6,
characterised in that the active surface (7; 11; 15) of the photo-diode (6; 10; 14) has the form of an oval surface.

8. A photo-diode (6; 10; 14) according to claim 6,
characterised in that the size of the active surface (7; 11; 15) of the photo-diode (6; 10; 14) is adapted to the impingement surfaces of at least two light cones from at least two optical fibres.

9. An optical receiver (5) containing a photo-diode (18),
characterised in that the two ends of two optical fibres (21, 22), which serve to transmit optical signals, are arranged together with a refractive medium (20) in front of the active surface (19) of the photo-diode (18) such that the photo-diode (18) can receive optical signals from both optical fibres (21, 22).

10. An optical receiver (5) according to claim 8,
characterised in that the refractive medium (20) has the form of a lens, in particular a spherical lens.
